(19) United States
(12) Patent Application Publication
(10) Pub. No.: US 2026/0012273 A1
(43) Pub. Date: Jan. 8, 2026

(54) LOCALIZING ATMOSPHERIC DUCT PHENOMENA BASED ON REMOTE INTERFERENCE

(71) Applicant: T-MOBILE INNOVATIONS LLC, Overland Park, KS (US)

(72) Inventors: Oliver Coudert, Arlington, VA (US); Jun Liu, Sammamish, WA (US)

(21) Appl. No.: 18/764,630

(22) Filed: Jul. 5, 2024

(51) Int. Cl. H04B 17/345; G01S 13/95; G01W 1/00; H04B 7/22

(52) U.S. Cl. CPC H04B 17/345; G01S 13/951; G01W 1/00; H04B 7/22

(57) ABSTRACT

Systems, methods, and software are disclosed herein for localizing an atmospheric duct based on remote interference. In an implementation, a method of operating a computing device for localizing an atmospheric duct includes detecting cross-cell interference during an uplink transmission at a network cell, identifying a source of the cross-cell interference based on a RIM reference signal embedded in the cross-cell interference, and generating localization information of an atmospheric duct based on position information of the network cell relative to the source and a propagation delay of the cross-cell interference.

### TECHNICAL FIELD

Aspects of the disclosure are related to the field of wireless communication networks, including detection and monitoring atmospheric ducts causing remote interference.

### BACKGROUND

Certain atmospheric conditions give rise to atmospheric ducts which can impact the performance of a wireless communication network. Atmospheric ducts can form within boundaries between layers of air masses and can extend for hundreds of kilometers. The boundaries of atmospheric ducts create a high level of refractivity by which signals can propagate, creating interference at network cells in locations far from the intended coverage area. Given the geographic extent of atmospheric ducts, this remote interference negatively impacts the quality and reliability of wireless networks by creating interference at network cells across vast areas.

The impact of atmospheric ducts can be particularly acute with time-division duplex (TDD) signals of wireless networks such as 5G networks. TDD transmissions are configured such that the downlink portion of a TDD transmission is followed by the uplink portion. When TDD transmissions of network base stations are carried by an atmospheric duct beyond their intended transmission distance, the time delay due to the propagation of these signals over hundreds of kilometers causes the downlink portions of the transmissions to be received during the uplink reception of TDD signals at remote cells. When transmissions of multiple network cells are carried by a duct, the accumulated interference can severely impact the ability of the remote cells to reliably receive uplink transmissions.

To address atmospheric duct conditions, networks can instigate mitigative responses to the remote interference. Such methods can include reducing transmission power, beamforming to limit the spread of transmissions, and other adaptive schemes. However, such schemes come at the cost of limiting throughput of network data traffic.

### OVERVIEW

Technology is disclosed herein for localizing an atmospheric duct based on remote interference. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to detect cross-cell interference during an uplink transmission at a network cell and to identify the source of the cross-cell interference based on a remote interference management (RIM) reference signal embedded in the cross-cell interference. The computing apparatus is then directed to generate localization information of an atmospheric duct based on position information of the network cell relative to the source and a propagation delay of the cross-cell interference.

In another example, a method of operating a computing device includes detecting cross-cell interference during an uplink transmission at a network cell, identifying a source of the cross-cell interference based on a RIM reference signal embedded in the cross-cell interference, and generating localization information of an atmospheric duct based on position information of the network cell relative to the source and a propagation delay of the cross-cell interference.

In yet another example of the technology disclosed herein, one or more computer readable storage media having program instructions stored thereon that, when executed by one or more processors, direct a computing apparatus to identify sources of transmissions detected at network cells of a wireless communication network based on remote interference management (RIM) reference signals embedded in the transmissions; generate localization information of an atmospheric duct based on position information of the network cells relative to the sources and propagation delays of the transmissions; generate a visual representation of the atmospheric duct based on the localization information; and display the visual representation of the atmospheric duct in a user interface.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for localization of an atmospheric duct in an implementation.

FIG. 2 illustrates a process for duct localization in an implementation.

FIG. 3 illustrates an operational environment for duct localization in an implementation.

FIG. 4 illustrates a workflow for duct localization in an implementation.

FIG. 5 illustrates a localization model for atmospheric ducts in an implementation.

FIG. 6 illustrates a user experience for a duct localization application in an implementation.

FIG. 7 illustrates an operational architecture of a wireless communication network in an implementation.

FIG. 8 illustrates an operational architecture for a wireless communication network in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for detection and localization of atmospheric ducting conditions based on interference-over-thermal (IoT) data captured at base stations or cells of a wireless communication network. Atmospheric ducting can occur in regions of the atmosphere where conditions are largely stable, e.g., when there is low convective energy in the atmosphere. In such conditions, transmissions from network base stations can be carried via an atmospheric duct to locations much farther away than were intended. Normally, the range of a transmission from one base station to another is about 60 kilometers. However, an atmospheric duct can carry such a transmission to base stations which are hundreds of kilometers away. For Time Division Duplex (TDD) transmissions, when those errant transmissions are received at a distant base station, the delay in receiving those remote signals will cause interference during the uplink portion of transmissions received at the base station.

To address the issue of remote interference, transmission signals may be encoded with information which identifies the source of the remote interference. These signals, known as remote interference management (RIM) reference signals (RS) per the Third Generation Partnership Project (3GPP) Technical Report 38.866 (version 16.1.0), allow a wireless communication network to identify where the interference is coming from and to mitigate the effects of the interference until the ducting condition, and the interference resulting from it, subsides. The transmitting cell or base station is known as the “aggressor,” and the cell or base station detecting the remote interference is known as the “victim.” Thus, when a victim cell detects remote interference, the wireless communication network can identify the aggressor cell from which the interfering transmission was sent. However, in reality, there are typically multiple aggressors transmitting signals at different times and at different distances from a victim cell, and the victim cell is subjected to a complex interference pattern (e.g., “sloping” interference) based on the variation in propagation delay.

Implementations of the technology disclosed herein leverage the ability to identify the source or aggressor of remote interference across a number of victim cells to detect atmospheric ducting conditions, to localize an atmospheric duct, to forecast the movement or duration of a detected duct, and to preemptively perform mitigation in anticipation of remote interference based on the duct. Beyond the applicability to wireless communication networks, duct detection and localization information can also be used to augment meteorological data for other uses, such as flight operations of vehicles such as unmanned aerial vehicles (UAVs), balloons, helicopters, gliders, and other kinds of aircraft by providing an indication of stable and therefore desirable flight conditions. Other users who may benefit from atmospheric duct modeling include amateur radio operators or hobbyists who seek out such conditions for boosting the distance of their transmissions. Such information can also be used to confirm, validate, or reinforce weather prediction models. For example, weather prediction models based on artificial intelligence (e.g., neural network models) can be trained to predict meteorological conditions based on the localization information of the atmospheric duct model.

In an implementation, to detect and localize atmospheric duct conditions based on cross-cell interference data, when a base station of a wireless communication network detects an increase in interference over a baseline or threshold level of interference, the network identifies a source of the cross-cell interference based on a RIM RS embedded in the interfering signal. As multiple such victim base stations report interference from remote, aggressor base stations, the network determines locations associated with the atmospheric ducting condition. As localization information for the ducting phenomenon is captured over a period of time, together with meteorological data of atmospheric conditions of the duct, the behavior of the duct (e.g., movement and duration) can be projected. Based on the detected behavior, mitigation can be performed in anticipation of remote interference at other cells. Moreover, as duct data and meteorological data are captured, the data can be used to train, for example, an artificial neural network for predicting duct phenomenon and duct behavior.

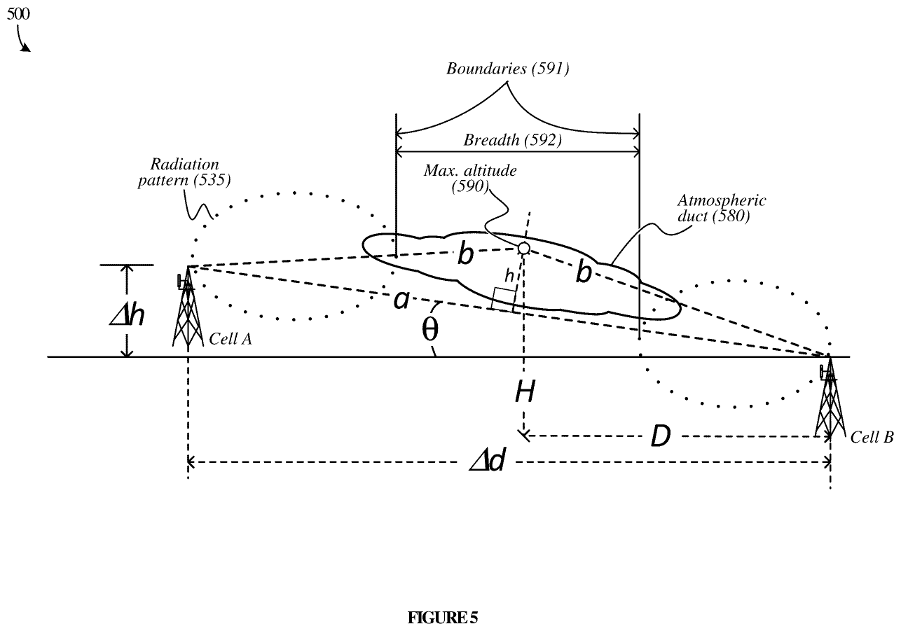

To localize an atmospheric duct based on RIM RS data, a location associated with the duct can be triangulated based on a localization model of ducting interference using physical data of the victim and aggressor cells. For example, upon identifying an aggressor in relation to a victim, the wireless communication network may access a base station database of physical characteristics to compute a location of the duct. The database may include such information as latitude, longitude, height (referenced to a common datum such as mean sea level), azimuth, antenna tilt (e.g., down-tilt), transmission power, and radiation pattern. The localization model of ducting interference from which a localization algorithm is derived is displayed in FIG. 5, discussed infra. The localization algorithm returns a probable location of zones in the atmosphere with a sufficiently high refractive index for causing ducting interference.

Having computed multiple locations of the atmospheric duct, the wireless communication network can project the travel and duration of the duct and proactively takes steps to mitigate any interference predicted based on the projections. Mitigation schemes can include, on the victim side, modifying the uplink symbol configuration, e.g., reducing the number of uplink symbols, but at the cost of uplink throughput. On the aggressor side, the transmission power can be reduced or the aggressor can mute or reconfigure the slot format of downlink symbols, but at the cost of downlink throughput. On either side, transmission scheduling can be modified, or a longer guard period can be implemented. Physical or spatial-domain solutions include modifying antenna height or down-tilt, interference nullification or rejection, and so on. Other schemes, such as beamforming or coordinated or synchronized communication between interfering cells, are also available.

Having computed multiple locations of the atmospheric duct, the wireless communication network may provide the information in real-time or near real-time, for example, a dashboard for network operators or others who may be impacted by the ducting. The wireless communication network may also host an application programming interface (API) by which other systems can access the information. Detection and localization information can be displayed on a geographic map to provide a visual indication of the location and movement of the duct. Other meteorological data related to ducting phenomenon may also be plotted, such as the index of refraction (or rate of change of), relative humidity, and convective energy (e.g., Convective Available Potential Energy or CAPE). Such information may be obtained from the National Oceanic and Atmospheric Administration (NOAA) or other sources of meteorological data.

Technical effects of the technology disclosed herein include enhanced meteorological monitoring with respect to wireless communication network operation, enabling proactive mitigation to be taken when ducts or favorable conditions for ducts have arisen or are projected to arise. This, in turn, improves network performance and user experience. Moreover, for users who benefit from ducting phenomenon, such information can be provided in real-time or near real-time. When integrated with meteorological data (temperature, barometric pressure, relative humidity, index of refraction, etc.) a comprehensive picture of atmospheric conditions can be obtained. Capturing an integrated dataset of ducting localization data and meteorological data can be used to train an artificial intelligence model to predict the onset of atmospheric ducting based on current weather conditions. In some scenarios, an AI model can be trained to forecast the behavior of a duct that has developed such as its growth, decay, or movement through the atmosphere.

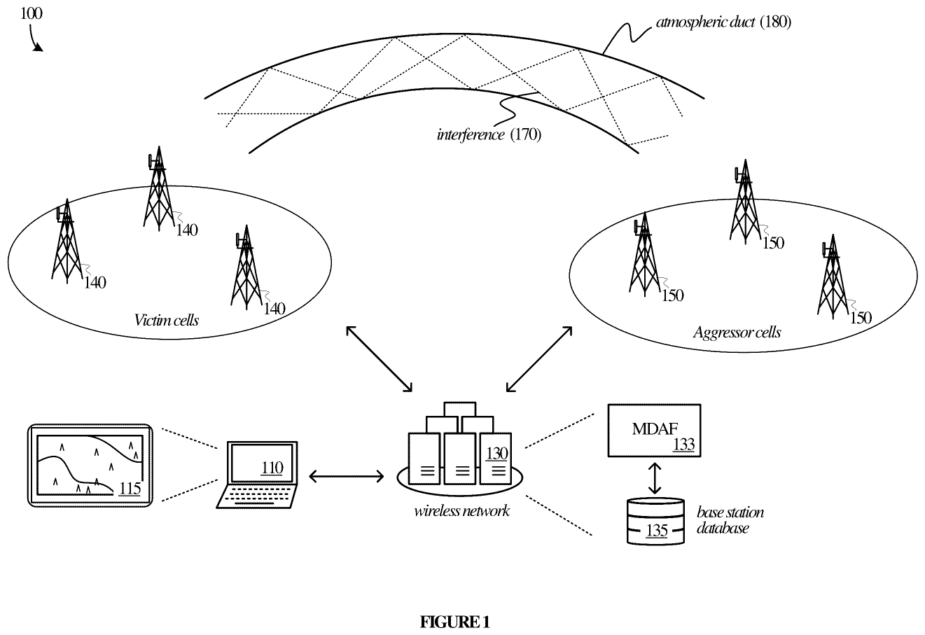

Turning now to the Figures, FIG. 1 illustrates operational environment 100 for detection and localization of atmospheric ducting based on remote interference for wireless communication networks. Operational environment 100 includes wireless network 130 in communication with computing device 110 which includes user interface 115. Wireless network 130 includes Meteorological Data Analysis Function (MDAF) 133, base station database 135, victim cells 140, and aggressor cells 150. Operational environment 100 also includes atmospheric duct 180 carrying interference 170 between aggressor cells 150 and victim cells 140.

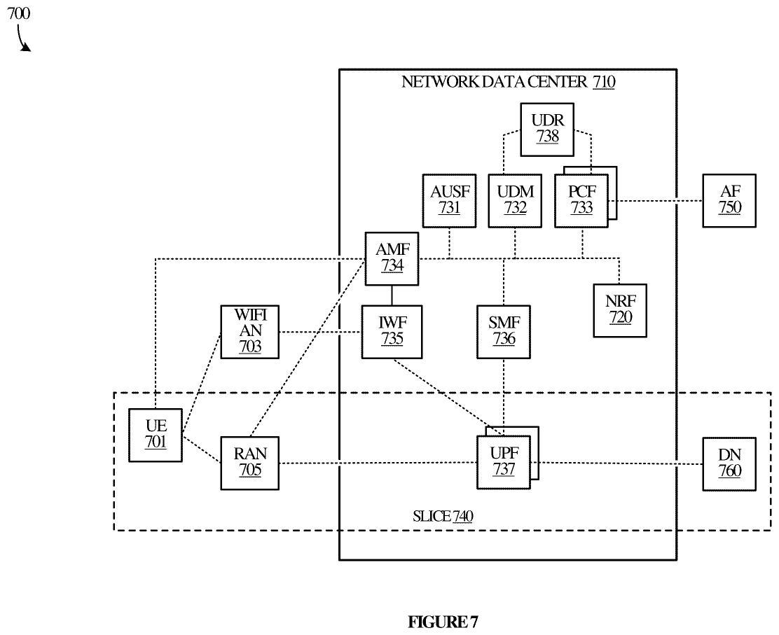

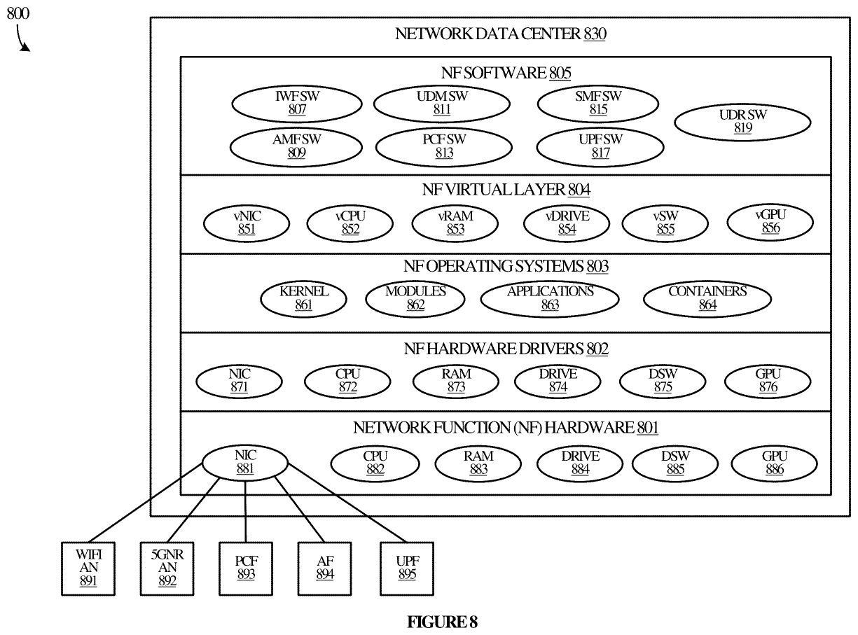

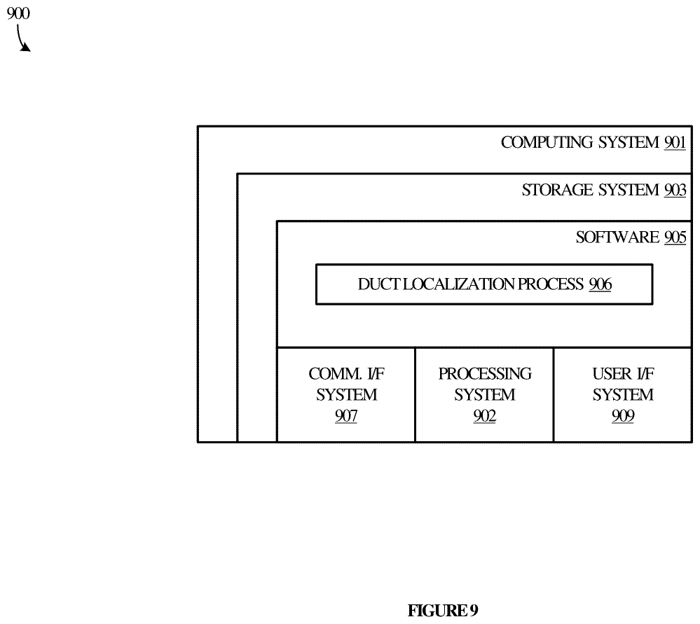

Wireless network 130 is representative of a communication network capable of using a Fifth Generation New Radio (5G-NR), LTE, 6G, or other protocol to communicate with computing devices such as computing device 110. Wireless network 130 is representative of a service-based architecture (SBA) which includes network functions such as MDAF 133 and base station database 135 which constitute the control and user planes of a wireless communication network core, of which network data center 710 of FIG. 7 and network data center 830 of FIG. 8 are representative. The network functions of wireless network 130 are implemented on one or more suitable computing devices, of which computing device 901 of FIG. 9 is representative. Examples of suitable computing devices include server computers, blade servers, and the like. The network functions of wireless network 130 may be implemented in the context of one or more data centers in a co-located or distributed manner, or in some other arrangement.

Functions of wireless network 130 include MDAF 133 and base station database 135 which are representative of functionalities or services of wireless network 130 for detecting and localizing cross-cell interference such as interference 170. MDAF 133 is representative of a network function for localizing and tracking atmospheric ducts such as atmospheric duct 180 based on interference detected at a base station of wireless network 130. Base station database 135 is representative of a network function of wireless network 130 which stores data relating to the physical characteristics of the various base stations of wireless network 130, including latitude, longitude, height (referenced to a common datum such as mean sea level), azimuth, antenna tilt (e.g., down-tilt), transmission power, and three-dimensional radiation pattern. In some implementations, MDAF 133 interconnects with a Network Data Analytics Function (NWDAF) and/or an Analytics Data Repository Function (ADRF) of wireless network 130. MDAF 133 and base station database 135 may be implemented on one or more suitable computing devices, of which computing device 901 of FIG. 9 is representative. Examples include server computers, blade servers, and the like.

Computing device 110 is representative of a device, such as a smartphone, computer, sensor, controller, radio, and/or some other user apparatus, of which computing system 901 in FIG. 9 is representative. In various implementations, computing device 110 locally executes an application, e.g., an application for tracking atmospheric ducting, which provides a local user experience in user interface 115, such as a dashboard displaying a geographic map with a visual indication of ducting phenomena. The application may execute locally on computing device 110, or on one or more servers of wireless network 130 in communication with computing device 110 over one or more wired or wireless connections, causing user interface 115 to be displayed on computing device 110.

Victim cells 140 and aggressor cells 150 are representative of equipment, such as Fifth Generation (5G) radio access nodes (RANs), long-term evolution (LTE) RANs, gNodeBs, eNodeBs, macrocells, NB-IoT access nodes, LP-WAN base stations, wireless relays, Wifi access nodes, and/or other wireless or wireline network transceivers, which can detect remote interference conducted by atmospheric ducting. Victim cells 140 and aggressor cells 150 host access networks using radio frequencies to provide wireless network connectivity to devices. To communicate with a network core of wireless network 130, cells or base stations such as victim cells 140 and aggressor cells 150 include receiving unit (RU) circuitry which communicates along fronthaul data paths to distributed unit (DU) circuitry which in turn communicates with central unit (CU) circuitry along midhaul data paths. Although illustrated as towers, victim cells 140 and aggressor cells 150 may include other physical configurations, including rooftop installations, small-cell sites, distributed antenna systems, vehicle-mounted systems, airborne access nodes, and so on. It may be appreciated that the labels “victim” and “aggressor” are provided for the sake of illustrating a scenario of cross-cell interference; any given cell can be a victim or aggressor with respect to other cells. For example, for a given pair of cells, one cell can be both a victim and an aggressor with respect to the other cell.

In various implementations, cells or base stations of wireless communication networks such as wireless network 130 transmit data using TDD. In a TDD transmission, time slots are allocated for sending and receiving data between the base stations and user devices which allows the same frequency to be used for both the uplink and downlink. Uplink symbols of TDD transmissions represent segments of time during which data is transmitted from a user device (e.g., smartphone, laptop) to a base station. The transmitted data may be a voice call, access to the Internet, and so on. Downlink symbols of TDD transmissions represent segments of time when a base station transmits data to a user device. To avoid interference during transmission, the time slots are separated in time; a typical TDD frame includes multiple downlink symbols, followed by a gap or guard period, followed by multiple uplink symbols. However, TDD transmissions can be disrupted when a base station receives stray (unintended) downlink symbols during the uplink phase of a TDD transmission. This disruption is caused by delays in the time it takes the stray transmissions to reach the (victim) base station from a remote (aggressor) base station. Indeed, the longer the distance between the aggressor and the victim, the greater the number of uplink symbols that will be disrupted. TDD transmissions may be embedded or encoded with a RIM reference signal by which the source of the stray transmission can be identified.

Atmospheric duct 180 is representative of an atmospheric phenomenon which forms when conditions in the atmosphere lead to variations in the refractive index of air at different altitudes, causing radio waves to bend or refract and travel along the curvature of the Earth, thereby extending the range and potentially interfering with signals from distant transmitters.

Interference 170 is representative of cross-cell interference detected by a victim cell or base station (e.g., victim cells 140) and originating from one or more aggressor cells or base stations (e.g., aggressor cells 150). Cross-cell interference occurs when signals from different cell sites overlap due to atmospheric conditions such as atmospheric ducting, leading to a degradation in the quality and reliability of wireless communications within those cells.

In a brief operational scenario of operational environment 100, atmospheric duct 180 forms, and TDD transmissions from aggressor cells 150 are carried by atmospheric duct 180 to victim cells 140 causing interference 170 at those cells. Interference 170 may manifest at victim cells 140 as a heightened level of background interference or increase in IoT (interference over thermal). Victim cells 140 detect interference 170 and identify the source of the interference as aggressor cells 150 based on RIM reference signals encoded in the TDD transmissions.

MDAF 133 receives data relating to interference 170 and computes a location associated with atmospheric duct 180. To compute the location, MDAF 133 executes an algorithm based on a localization model of cross-cell interference based on atmospheric detecting. To execute the localization algorithm, MDAF 133 accesses physical data of the victim cell(s) and aggressor(s) to infer a location of atmospheric duct 180. As interference 170 is detected at the different ones of victim cells 140 originating from different ones of aggressor cells 150 over a period of time, MDAF 133 captures localization data for atmospheric duct 180 and tracks any movement, growth, and/or decay of atmospheric duct 180 over time.

Based on the collected localization data, MDAF 133 may generate data for a visual representation of atmospheric duct 180 for display (e.g., a dashboard for tracking ducting phenomena) on a user computing device, such as in user interface 115 of computing device 110. The display may include a geographic map over which a visual representation of atmospheric duct 180 is displayed. The display may also include meteorological data for the atmospheric conditions in the vicinity of atmospheric duct 180, such as temperature, barometric pressure, relative humidity, convective energy, and refractive index. The meteorological data may be obtained from third-party sources such as NOAA databases and/or from sensors onboard cells of wireless network 130.

In addition to providing real-time or near real-time tracking of atmospheric duct phenomenon, MDAF 133 may also predict the occurrence of atmospheric ducts and the movement or duration of ducts based on historical data. To forecast duct formation and behavior, localization data and atmospheric conditions (meteorological) data may be used to train an artificial intelligence or machine learning model (e.g., an artificial neural network) to forecast the formation of atmospheric ducts or the behavior of ducts based on current atmospheric conditions. For example, a machine learning algorithm may be trained to determine the probable location of meteorological events such as zones in the atmosphere with a high refractive index that can cause ducting interference. Based on such forecasts, a network operator can take steps to proactively mitigate the predicted interference to ensure the quality and reliability of communication on the network.

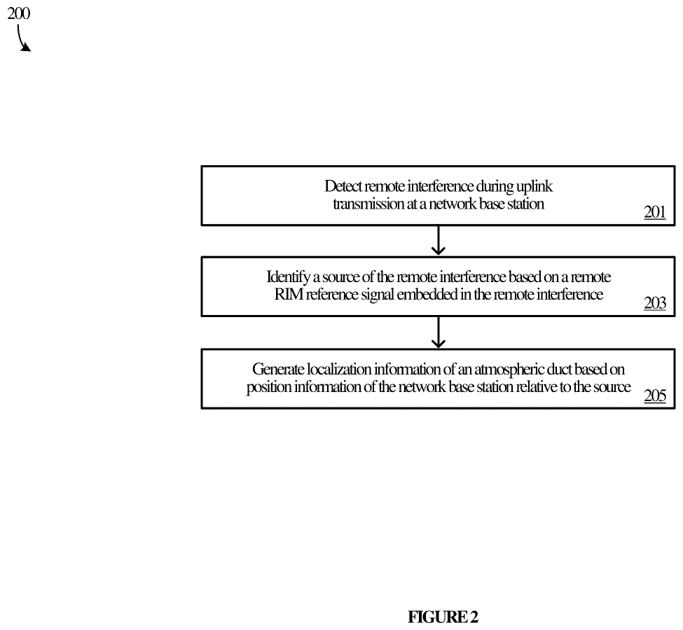

FIG. 2 illustrates a method of detecting and localizing atmospheric ducting or conditions for atmospheric ducting for wireless communication networks in an implementation, herein referred to as process 200. Process 200 may be implemented in program instructions in the context of any of the software applications, modules, components, or other such elements of one or more computing devices of a wireless communication network.

In process 200, a wireless communication network detects remote interference during an uplink transmission at a network base station (step 201). In an implementation, a wireless network, such as a 5G-NR network, detects remote interference when uplink symbols of a TDD transmission from one network base station are received at another network base station that is not the intended recipient of the uplink symbols. For example, transmissions from one or more cells may be carried via an atmospheric duct beyond the expected radiation pattern to other cells, causing cross-cell interference (also known as cross-link interference) at those other cells. Under normal conditions, a base station transmission travels approximately 60 kilometers; when carried by an atmospheric duct, such transmissions may be carried to base stations that are hundreds of kilometers from the source. When cross-cell interference occurs, the wireless network may detect a higher-than-normal level of background noise at the base station and/or a degraded signal-to-noise ratio (SNR) in the uplink reception. For example, the network base station affected by the cross-cell interference may communicate the higher-than-normal level of background noise and/or the degraded SNR information to the network core of the wireless network.

Typically, interference arising from atmospheric ducting only rarely affects a single cell of a wireless network. Rather, remote or cross-cell interference is detected at multiple base stations in a given geographic area or region with the interference originating from another group of base stations at a remote geographic area or region. In these scenarios, cross-cell interference may be detected based on the distinctive sloping pattern of interference across the portion of uplink symbols of a TDD transmission. The sloping pattern arises from the accumulation of stray signals based on the variation in propagation delay as transmissions from different distances are received at the victim cell. As such, although process 200 is described in terms of interference detected at a single victim cell, it may be appreciated that the steps of process 200 may be implemented for interference at multiple victim cells originating from multiple aggressor cells when the interference arises from a single atmospheric duct event. The data collected from multiple detections and localizations corresponding to the duct event may be aggregated to provide a more comprehensive understanding (e.g., breadth or shape, movement, duration) of the duct.

The wireless network identifies a source of the remote interference based on a RIM reference signal embedded in the remote interference (step 203). In an implementation, the wireless network determines the source of the interference to be from a second (aggressor) cell based on a RIM reference signal encoded in the transmission which is causing the remote or cross-cell interference. In various implementations, each transmitting cell generates a unique RIM reference signal by which other cells can identify the source of the transmission. For example, the RIM reference signals may be transmitted as Orthogonal Frequency Division Multiplexing (OFDM) symbols encoded at specified symbol slots and subcarriers in a TDD transmission. For example, a network base station affected by the cross-cell interference may forward the RIM reference signals encoded in the corresponding transmissions that caused the interference to the network core of the wireless network.

The wireless network generates localization information of an atmospheric duct based at least on position information of the network base station relative to the source (step 205). In an implementation, having identified the aggressor cell of an interfering transmission received at the victim cell, the wireless network generates location data for the atmospheric duct based on a localization model and the transmission delay. In particular, the model receives as input the distance between the victim and the aggressor, a difference in vertical height between the victim and the aggressor, and a propagation delay of the interfering transmission received at the victim cell. The model assumes that the time of propagation between the two cells is no greater than the speed of light and that the ducting phenomenon exists over an area which overlaps the three-dimensional radiation patterns of the victim and aggressor cells. The model infers a maximum altitude or ceiling of the atmospheric duct at a midpoint of a propagation path between the victim and the aggressor the path length of which is determined by the propagation delay. In assuming that the boundaries of the atmospheric duct extend to at least the edge of or overlap with the radiation pattern of each cell, a minimum horizontal or lateral span of the duct can be inferred based on the boundaries. Thus, the location and breadth or shape of an atmospheric duct can be determined. Moreover, by aggregating the localization data from multiple victim cells in an area where a duct is detected, a more detailed picture of the location and contours or extent of the duct can be determined with a greater level of confidence.

Having determined the location and boundaries of a duct, the wireless network can output this information in a number of ways. The wireless network can generate a three-dimensional visualization of the duct over a geographic map for display in a dashboard of a duct tracking application. Such a display may indicate the shape of the duct as a function of altitude based on the localization information. The wireless network may also output the localization information via an API by which third-party users, such as operators of small aircraft or atmospheric information services, can obtain the information. In still other scenarios, the localization data may inform mitigation services of the wireless network to select and perform mitigation at the victim and/or aggressor cells to mitigate cross-cell interference as or before it occurs. Moreover, as the localization information is captured over time, the movement as well as growth or decay of the duct can be tracked.

In addition to the localizing a point in the atmospheric duct, the wireless network may also capture data relating to atmospheric conditions at the time of the interference. Information such as temperature, barometric pressure, relative humidity, index of refraction, and convective energy of the atmosphere in the vicinity of the duct may be captured and displayed, for example, in conjunction with the duct information in the dashboard. More importantly, a comprehensive understanding of the atmospheric conditions from the onset of the duct to the time the duct expires can be used to train ducting models, such as artificial intelligence models, for predicting ducting phenomenon, including predicting atmospheric conditions when a duct is likely to form, the movement of a duct that has formed based on atmospheric conditions, and the projected duration of the duct.

Referring once again to FIG. 1, operational environment 100 illustrates a brief example of process 200 as employed by elements of operational environment 100. In operation, wireless network 130 detects interference 170 during an uplink transmission at one or more victim cells 140. In an implementation, interference 170 is detected at one or more of victim cells 140 in the form of a heightened level of background interference, a degraded SNR, an interference profile with respect to the uplink reception, or some other means.

Wireless network 130 identifies one or more sources of interference 170 based on RIM reference signals encoded in the transmissions causing the interference. In an implementation, one or more RIM reference signals are detected in transmissions from various ones of aggressor cells 150 which are causing interference 170 at one or more of victim cells 140.

Wireless network 130 generates localization information of atmospheric duct 180 based on position information of at least one of victim cells 140 receiving interference 170 and at least one of aggressor cells 150 emitting transmissions causing the interference. Having identified interference 170 at one of victim cells 140 originating from one of aggressor cells 150, wireless network 130 executes a software application or network function such as MDAF 133 to localize atmospheric duct 180. To perform the localization, wireless network 130 accesses physical data of victim and aggressor cells for input to an algorithm for determining the location, altitude or ceiling, and boundaries of atmospheric duct 180.

In an implementation, wireless network 130 performs process 200 with respect to various ones of victim cells 140 and aggressor cells 150 to generate a time-dependent dataset describing the location and boundaries of atmospheric duct 180. Using the dataset, MDAF 133 derives data for generating a visual representation of atmospheric duct 180 which can be used to illustrate duct behavior, such as movement, growth/decay, etc. For example, a visual representation of atmospheric duct 180 may be superimposed over a geographic map for display in a dashboard of information relating to atmospheric duct 180 for display in user interface 115 of computing device 110. In various implementations, the dashboard includes a geographic map of the location of atmospheric duct 180, such as a satellite-view of the area, over which a visual representation of atmospheric duct 180 is displayed and continually updated as more data is received. The dashboard may also display and continually update information about the atmospheric conditions (e.g., temperature, barometric pressure, convective energy, refractive index, relative humidity) in the vicinity of the duct. In some scenarios, in the dashboard, the user may view the breadth of atmospheric duct 180 according to altitude as determined by MDAF 133 based on the localization data. The dashboard may also display a time-lapse sequence of the localization data of atmospheric duct 180 to visually indicate the behavior of the duct, such as its movement, growth, and decay. For example, the sequence may include duct localization data captured at five-minute intervals which when displayed in sequence simulate the movement or drift of the duct over a specified period of time.

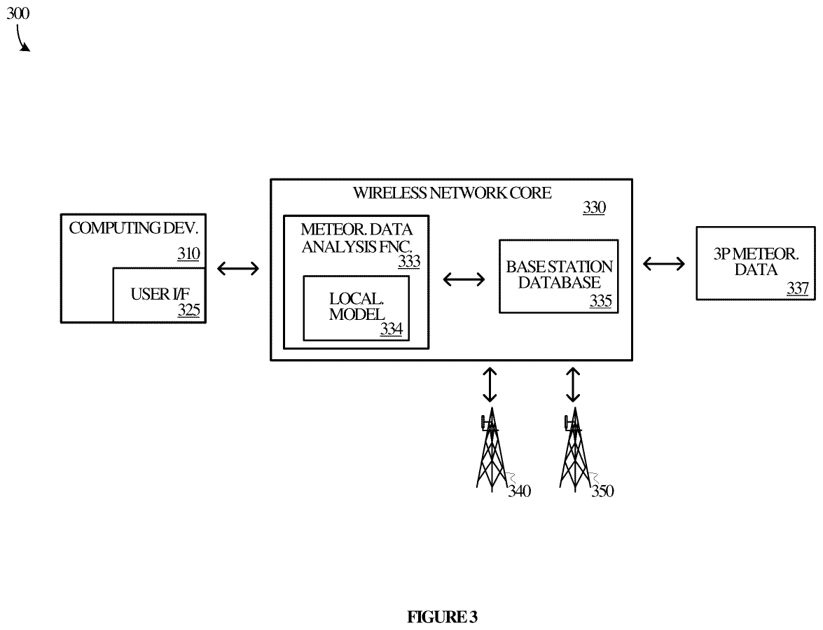

FIG. 3 illustrates operational architecture 300 for detecting and localizing atmospheric ducts based on cross-cell interference in an implementation. Operational architecture 300 includes wireless network 330 and computing device 310. Wireless network 330 includes meteorological data analysis function (MDAF) 333, base station database 335, victim cells 340, and aggressor cells 350. MDAF 333 includes localization model 334. Computing device 310 includes user interface 325. Operational architecture 300 also includes third-party (3P) meteorological data source(s) 337.

Wireless network 330 is representative of a wireless communication network, such as a 5G-NR network, of which wireless network 130 of FIG. 1 is representative. Wireless network 330 is representative of a communication network capable of using a Fifth Generation New Radio (5G-NR), LTE, 6G, or other protocol to communicate with computing devices such as computing device 310. Wireless network 330 is representative of a service-based architecture (SBA) which includes network functions such as MDAF 333 and base station database 335 which constitute the control and user planes of a wireless communication network core, of which network data center 710 of FIG. 7 and network data center 830 of FIG. 8 are representative. The network functions of wireless network 330 are implemented on one or more suitable computing devices, of which computing device 901 of FIG. 9 is representative. Examples of suitable computing devices include server computers, blade servers, and the like. The network functions of wireless network 330 may be implemented in the context of one or more data centers in a co-located or distributed manner, or in some other arrangement.

Functions of wireless network 330 include MDAF 333 and base station database 335 which are representative of functionalities or services of wireless network 330 for detecting and localizing cross-cell interference. MDAF 333 is representative of a network function for localizing and tracking atmospheric ducts based on interference detected at a base station of wireless network 330. Base station database 335 is representative of a network function of wireless network 330 which stores data relating to the physical characteristics of the various base stations of wireless network 330, including latitude, longitude, height (referenced to a common datum such as mean sea level), azimuth, antenna tilt (e.g., down-tilt), transmission power, and three-dimensional radiation pattern. In some implementations, MDAF 333 interconnects with a Network Data Analytics Function (NWDAF) and/or an Analytics Data Repository Function (ADRF) of wireless network 330. MDAF 333 and base station database 335 may be implemented on one or more suitable computing devices, of which computing device 901 of FIG. 9 is representative. Examples include server computers, blade servers, and the like.

MDAF 333 includes localization model 334 comprising an engine or algorithm which receives as input physical characteristics of base stations such as victim cell 340 and aggressor cell 350 and a propagation distance from cross-cell interference and outputs localization data for an atmospheric duct carrying the cross-cell interference. In various implementations, the localization data returned by localization model 334 includes an inferred altitude or ceiling of the duct, an inferred extent or breadth of the duct, as well as other information such as a three-dimensional dataset which represents the duct based on multiple instances of cross-cell interference from multiple victim and aggressor cells. The three-dimensional model may define a shape of the duct including inferred horizonal boundaries or contours of the duct. In various implementations, localization model 334 includes information relating to changes in the duct size, shape, and movement in the atmosphere.

In some implementations, localization model 334 is an artificial intelligence model (e.g., an artificial neural network) which generates localization data describing an atmospheric duct based on the physical characteristics of the cells, the propagation delay, and atmospheric conditions of the duct as may be obtained from third-party meteorological data sources 337. In various implementations, MDAF 333 includes other machine learning engines or models relating to atmospheric ducts, such as AI models for forecasting duct formation and movement.

Computing device 310 is representative of a device, such as a smartphone, computer, sensor, controller, radio, and/or some other user apparatus, of which computing system 901 in FIG. 9 is representative. In various implementations, computing device 310 locally executes an application, e.g., an application for tracking atmospheric ducting, which provides a local user experience in user interface 325, such as a dashboard displaying a geographic map with a visual indication of ducting phenomenon. The application may execute locally on computing device 310, or on one or more servers of wireless network 330 in communication with computing device 310 over one or more wired or wireless connections, causing user interface 325 to be displayed on computing device 310.

Victim cells 340 and aggressor cells 350 are representative of equipment, such as Fifth Generation (5G) radio access nodes (RANs), long-term evolution (LTE) RANs, gNodeBs, eNodeBs, macrocells, NB-IoT access nodes, LP-WAN base stations, wireless relays, Wifi access nodes, and/or other wireless or wireline network transceivers, which can detect remote interference conducted by atmospheric ducting. Victim cells 340 and aggressor cells 350 host access networks using radio frequencies to provide wireless network connectivity to devices. To communicate with a network core of wireless network 330, cells or base stations such as victim cells 340 and aggressor cells 350 include receiving unit (RU) circuitry which communicates along fronthaul data paths to distributed unit (DU) circuitry which in turn communicates with central unit (CU) circuitry along midhaul data paths. Although illustrated as towers, victim cells 340 and aggressor cells 350 may include other physical configurations, including rooftop installations, small-cell sites, distributed antenna systems, vehicle-mounted systems, airborne access nodes, and so on.

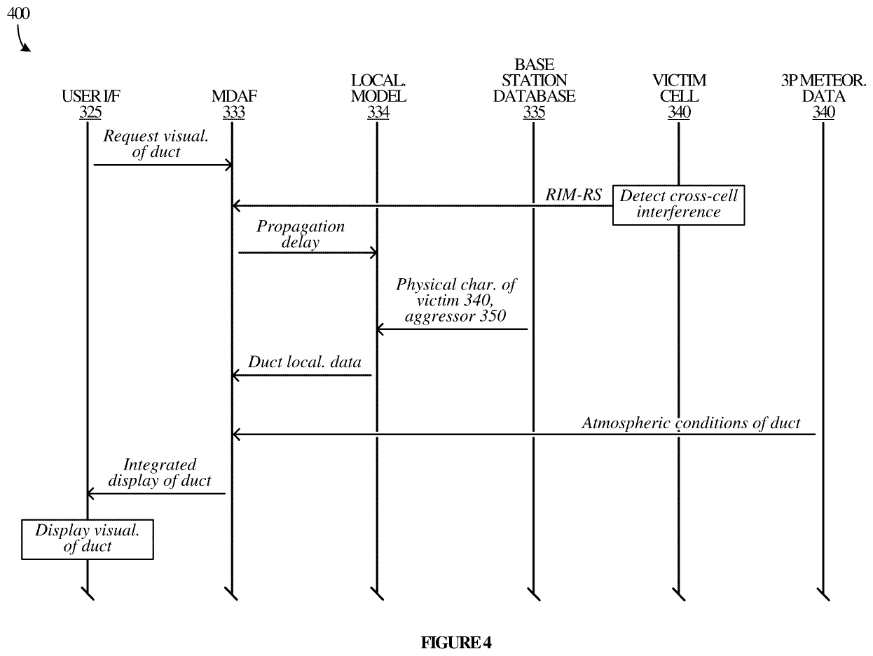

FIG. 4 illustrates workflow 400 for localizing an atmospheric duct based on cross-cell interference in an implementation referring to elements of operational architecture 300. In operation, wireless network core 330 may host an application for forecasting and tracking atmospheric ducts which displays a local user experience in user interface 325 of computing device 310. In workflow 400, user interface 325 receives a request for a visualization of an atmospheric duct. MDAF 333 receives information relating to cross-cell interference occurring at victim cell 340. For example, MDAF 333 may receive a RIM reference signal from a stray transmission signal causing the interference with uplink reception at victim cell 340, and MDAF determines the aggressor based on the RIM reference signal. Alternatively, MDAF 333 may receive the interference pattern or a stray transmission signal causing the interference from victim cell 340 and extract the RIM reference signal to identify the aggressor. In either case, MDAF 333 determines a propagation delay of the cross-cell interference based on the identities of the victim cell and the aggressor cell.

Next, MDAF 333 executes localization model 334 to compute duct localization data based on the propagation delay and physical characteristics of victim cell 340 and aggressor cell 350. Duct localization data includes a location of the duct (e.g., geographic area), an altitude or ceiling of the duct, and boundaries of the duct. Localization model 334 outputs the localization data to MDAF 333.

Continuing with workflow 400, MDAF 333 also receives data describing the atmospheric conditions in the vicinity of the duct from various network or third-party meteorological data sources 337. The relevant atmospheric conditions include temperature and barometric pressure, relative humidity, convective energy in the atmosphere, and refractivity index.

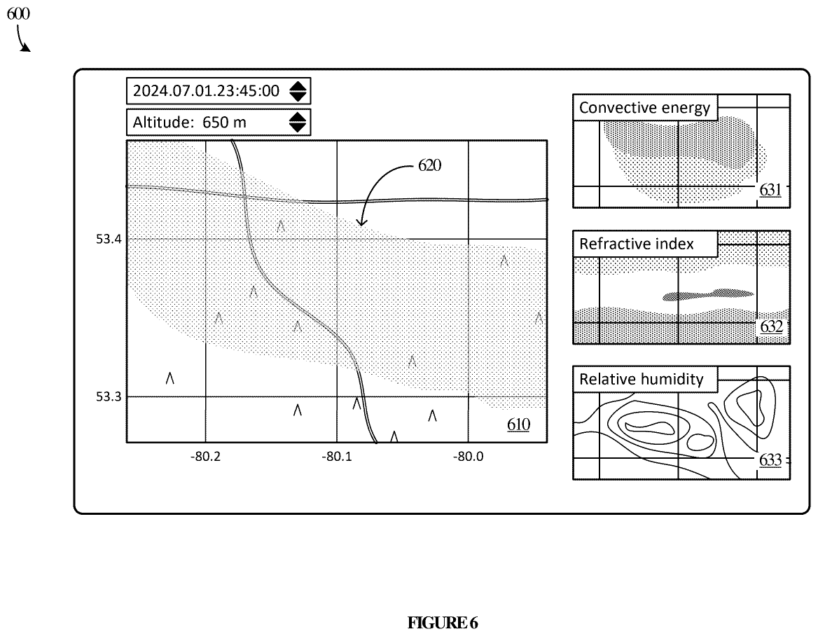

MDAF 333 generates data for an integrated display of the duct based on the localization data and the atmospheric conditions data, an implementation of which is depicted in FIG. 6, discussed infra. The display may include a geographic map of the area of the duct along with a visual representation of the duct based on the localization data. The display may also include visualizations of atmospheric conditions in and around the duct. The display may also provide a dynamic visualization of the duct in a sequence of visual representations of the duct localization data captured over time. The dynamic visualization can be used to monitor the behavior of the duct over time. In various implementations, the display may also provide forecasts relating to the life or duration of the duct, its movement, its size, and so on. Based on the forecasts, a user at computing device 310 may initiate mitigative actions for network cells which may be affected by the duct based on the forecasted movement.

FIG. 5 illustrates localization model 500 for localizing atmospheric ducts in an implementation. To localize an atmospheric duct, when a cell receives an errant transmission from another cell which was relayed through the duct, the altitude and boundaries of the duct are computed based on the location information and radiation patterns of the cells and the transmission delay.

To compute the localization data, localization model 500 receives as input location data of the two cells and the propagation delay of the errant transmission. The location data of two cells, Cell A and Cell B, includes the geographic location of the cells (e.g., latitude and longitude), the altitudes of the cells relative to mean sea level, and the distance Δd between the cells. The angle of elevation θ is computed based on the difference in altitude Δh between the two cells and the distance Δd according to Equation 1:

$$θ = {tan}^{- 1} \frac{Δ h}{Δ d} \qquad Equation 1$$

Point 590 indicates a maximum altitude of duct 580 based on the propagation delay. The altitude H at point 590 can be determined relative to a known location such as Cell A or Cell B. (As illustrated in localization model 500 in FIG. 5, the coordinates of point 590 are determined relative to Cell B.) To compute the maximum altitude H, a propagation distance 2b is computed based on the propagation delay of the errant transmission which is assumed to travel at the speed of light. Segments b in localization model 500 reflect half the propagation distance, forming an isosceles triangle with base a, where a is a straight line segment connecting the two cells. The height h of the triangle is computed according to Equation 2:

$$h = \sqrt{{b}^{2} - \frac{{a}^{2}}{4}} \qquad Equation 2$$

With θ and h determined, the maximum altitude H can be computed relative to the altitude of Cell B according to Equation 3:

$$H = \frac{a}{2} sin θ + h cos θ \qquad Equation 3$$

Similarly, distance D of the computed maximum altitude relative to Cell B can be computed according to Equation 4:

$$D = \frac{a}{2} cos θ - h sin θ \qquad Equation 4$$

Distance D can then be used to identify an absolute geographic location (e.g., latitude and longitude) of the inferred maximum altitude H at point 590 in that a ground location corresponding to point 590 lies a distance D from Cell B along the bearing of the path connecting Cells A and B. Thus, the localization information determined based on localization model 500 can be used to provide an indication of the three-dimensional location of atmospheric duct 580 for tracking or mapping purposes.

In addition to determining a maximum altitude of the duct, boundaries 591 of duct 580 can be inferred based on three-dimensional radiation patterns 535 of the Cells A and B. Boundaries 591 indicate a minimum lateral propagation distance across the duct between the cells as indicated by duct breadth 592. For example, the boundaries or contours of a duct can be determined based on the maximum transmission distances of the two cells.

Using localization model 500, a three-dimensional model or representation of an atmospheric duct can be computed based on cross-cell interference between two cells (e.g., Cell A and Cell B). Because cross-cell interference typically involves multiple victim cells and multiple aggressor cells, a comprehensive localization dataset and detailed three-dimensional model can be created and continually updated when a duct is detected. In the aggregate the localization dataset can be used to generate a visualization of the duct (e.g., superimposed on a map) and the behavior of the duct, such as its growth and decay in size, change in altitude, and drift, can be tracked.

FIG. 6 illustrates user experience 600 including a dashboard for displaying atmospheric duct detection and localization information based on cross-cell interference in an implementation. User experience 600 may be hosted by a network function or application of a wireless communication network for forecasting and tracking atmospheric ducts. User experience 600 may be displayed on a user computing device (e.g., computing device 110 of FIG. 1).

In user experience 600, real-time or near real-time visual representation 620 of an atmospheric duct is superimposed on geographic map 610. Visual representation 620 is generated based on duct localization information determined from cross-cell interference. For example, multiple network base stations may detect transmissions carried by the duct from network aggressor cells beyond the intended propagation distance. The duct localization information includes inferred altitudes of the duct at various points between the victim and aggressor cells. The localization information also includes boundaries or contours which are inferred based on the radiation patterns of the victim and aggressor cells. In various implementations, the user can view a representation of the duct at selected altitudes based on the duct localization information.

User experience 600 also displays visual representations 631-633 of various relevant atmospheric conditions in the vicinity of the duct, including convective energy, refractive index, and relative humidity. As with visual representation 620, visual representations 631-633 are geographic representations of weather patterns detected in the atmosphere in the vicinity of the duct. Atmospheric conditions may be obtained from third-party sources of meteorological data and integrated into the display according to the time and location of the duct.

In some implementations, user experience 600 may display a time-lapse sequence of duct visualizations to convey a history of duct formation, growth/decay, and movement. In some implementations, user experience 600 may also display a forecast of duct behavior based on the historical localization data and historical atmospheric conditions data. The forecast may project the movement and duration of an existing duct. In some scenarios, user experience 600 may indicate when atmospheric conditions are favorable for duct formation.

To generate forecasts of duct formation or behavior of existing ducts, the wireless communication network may execute a network function or application including a trained artificial neural network or other type of machine learning model. For example, the model may be trained using datasets comprising historical duct localization data and corresponding atmospheric conditions data spanning life cycles of atmospheric ducts. The training data may include ducts formed in a variety of locations and at different times of the year so the training results in a robust model. An AI model may be trained to output an indication of atmospheric conditions which are favorable to duct formation. An AI model may also be trained to output a forecast of the behavior of an existing duct, e.g., the duration, growth/decay, and drift of the duct through the atmosphere.

FIG. 7 illustrates exemplary wireless communication system 700 that serves wireless User Equipment (UE) 701 based on policies. Wireless communication system 700 includes UE 701, Wifi Access Node (AN) 703, 5GNR access node 705, Interworking Function (IWF) 735, Access and Mobility Management Function (AMF) 734, Authentication Server Function (AUSF) 731, Unified Data Management (UDM) 732, Policy Control Functions (PCFs) 733, Session Management Function (SMF) 736, User Plane Function (UPF) 737, Uniform Data Repository (UDR) 738, and Application Function (AF) 750. UDR 738 stores network data including subscriber profiles including identities, subscription details, service preferences, authentication credentials, and billing information. UDR 738 may also store policy data such as network rules, access rules, mobility rules, charging rules, and so on. AF 750 may provide policies applicable to control plane functions, that is, to the application, presentation, and/or session layers of the OSI protocol stack. IWF 735 includes non-3GPP IWFs (N3IWFs) for providing untrusted non-3GPP access to network data center 710, such as access via a non-cellular access network.

Continuing with wireless communication system 700, wireless network slice 740 includes UPF 737 and SMF 736. Wireless network slice 740 is representative of a dynamically allocated slice of finite duration selected for hosting service from DN 760 to UE 701 according to the technology disclosed herein, including process 200 or workflow 400. DN 760 is representative of a data network, Internet access, third-party resource, or other endpoint of an end-to-end communication path from UE 701. For example, DN 760 may be an application or application service which requests a time-bound dynamically allocated slice for the wireless network of network data center 710 for service to UE 701.

In an implementation, UE 701 communicates with network data center 710 via 5G-NR access node 705 or Wifi access node 703. UE 701 requests access to DN 760 via the communication network of network data center 710, e.g., via wireless network slice 740. SMF 736 receives the access request from AMF 734 and other network functions of the communication network which are enforcing various aspects of the access request from UE 701. SMF 736 receives policies or policy decisions from AUSF 731, UDM 732, PCF 733, and/or AMF 734.

FIG. 8 illustrates exemplary network data center 830, a network core of a wireless communication system, of which wireless network 130 of FIG. 1 is representative. Network data center 830 includes network function (NF) software 805, network function virtual layer 804, network function operating systems 803, network function hardware drivers 802, and network function hardware 801.

Network function software 805 of network data center 830 includes software for executing various network functions: IWF software 807, AMF software 809, UDM software 811, PCF software 813, SMF software 815, UPF software 817, and UDR software 819. Other network function software, such as network repository function (NRF) software, are typically present but are omitted for clarity.

Network function virtual layer 804 includes virtualized components of network data center 830, such as virtual NIC 851, virtual CPU 852, virtual RAM 853, virtual drive 854, virtual software 855, and virtual GPU 856. Network operating systems 803 includes components for operating network data center 830, including kernels 861, modules 862, applications 863, and containers 864 for network function software execution. Network function hardware drivers 802 include software for operating network function hardware 801 of network data center 830, including network interface card (NIC) drivers 871 for network interface cards (NICs) 881, CPU drivers 872 for CPUs 882, RAM drivers 873 for RAM 883, flash/disk drive drivers 874 for flash/disk drives 884, data switch (DSW) drivers 875 for data switches 885, and drivers 876 for GPUs 886. Network interface cards 881 of network function hardware 801 include hardware components for communicating with Wifi access node 891, 5GNR access node 892, PCF 893, application server 894, and UPF 895.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements duct localization process 906, which is (are) representative of the duct localization processes discussed with respect to the preceding Figures, such as process 200 and workflow 400. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including duct localization process 906) may be implemented in program instructions and among other functions may, when executed by processing system 902, direct processing system 902 to operate as described with respect to the various operational scenarios, sequences, and processes illustrated herein. For example, software 905 may include program instructions for implementing a duct localization process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support duct localization processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
detect, by a network function of a wireless communication network, cross-cell interference during an uplink transmission at a network cell;
identify a source of the cross-cell interference based on a remote interference management (RIM) reference signal embedded in the cross-cell interference; and
generate localization information of an atmospheric duct based at least on position information of the network cell relative to the source and a propagation delay of the cross-cell interference.

2. The computing apparatus of claim 1, wherein the program instructions further direct the computing apparatus to generate additional localization information of the atmospheric duct based on the cross-cell interference detected at least one other network cell.

3. The computing apparatus of claim 2, wherein the program instructions further direct the computing apparatus to display, in a user interface of an application hosted by the wireless communication network, a dashboard comprising geographic representation of the atmospheric duct based on the localization information and the additional localization information.

4. The computing apparatus of claim 3, wherein the dashboard further comprises a geographic representation of meteorological data in a vicinity of the atmospheric duct.

5. The computing apparatus of claim 3, wherein the program instructions further direct the computing apparatus to forecast a movement of the atmospheric duct based on localization information of the atmospheric duct.

6. The computing apparatus of claim 1, wherein the position information of the network cell relative to the source comprises an altitude difference between the network cell and the source and a distance between the network cell and the source.

7. The computing apparatus of claim 1, wherein the localization information comprises an altitude of the atmospheric duct and a geographic location of the atmospheric duct.

8. The computing apparatus of claim 1, wherein the program instructions further direct the computing apparatus to receive, from an application, a request for the localization information via an application programming interface hosted by the wireless communication network.

9. A method of operating a wireless communication network comprising:
detecting, by a network function of the wireless communication network, cross-cell interference during an uplink transmission at a network cell;
identifying a source of the cross-cell interference based on a remote interference management (RIM) reference signal embedded in the cross-cell interference; and
generating localization information of an atmospheric duct based on position information of the network cell relative to the source and a propagation delay of the cross-cell interference.

10. The method of claim 9, further comprising generating additional localization information of the atmospheric duct based on the cross-cell interference detected at least one other network cell.

11. The method of claim 10, further comprising displaying, in a user interface of an application hosted by the wireless communication network, a dashboard comprising geographic representation of the atmospheric duct based on the localization information and the additional localization information.

12. The method of claim 11, wherein the dashboard further comprises a geographic representation of meteorological data in a vicinity of the atmospheric duct.

13. The method of claim 11, further comprising forecasting a movement of the atmospheric duct based on localization information of the atmospheric duct.

14. The method of claim 9, wherein the position information of the network cell relative to the source comprises an altitude difference between the network cell and the source and a distance between the network cell and the source.

15. The method of claim 9, wherein the localization information comprises an altitude of the atmospheric duct and a geographic location of the atmospheric duct.

16. One or more computer readable storage media having program instructions stored thereon that, when executed by one or more processors, direct a computing apparatus to at least:
identify sources of transmissions detected at network cells of a wireless communication network based on remote interference management (RIM) reference signals embedded in the transmissions;
generate localization information of an atmospheric duct based on position information of the network cells relative to the sources and propagation delays of the transmissions;
generate a visual representation of the atmospheric duct based on the localization information; and
display the visual representation of the atmospheric duct in a user interface.

17. The one or more computer readable storage media of claim 16, wherein, for a given transmission between a given network cell and a given source, the position information comprises an altitude difference between the given network cell and the given source and a distance between the given network cell and the given source.

18. The one or more computer readable storage media of claim 17, wherein the localization information comprises an altitude of the atmospheric duct and a geographic location of the atmospheric duct.

19. The one or more computer readable storage media of claim 18, wherein the localization information further comprises boundaries of the atmospheric duct based on radiation patterns of the given network cell and the given source.

20. The one or more computer readable storage media of claim 16, wherein the user interface further comprises a geographic representation of meteorological data in a vicinity of the atmospheric duct.
